(19) United States
(12) Patent Application Publication
(10) Pub. No.: US 2017/0113332 A1
(43) Pub. Date: Apr. 27, 2017

(54) RATCHET WRENCH

(71) Applicants: CHUN-WEI YANG, Taichung (TW); ZHE-PING ZHANG, Taichung (TW)

(72) Inventors: CHUN-WEI YANG, Taichung (TW); ZHE-PING ZHANG, Taichung (TW)

(21) Appl. No.: 14/918,598

(22) Filed: Oct. 21, 2015

(51) Int. Cl. B25B 13/46

(52) U.S. Cl. CPC B25B 13/463

(57) ABSTRACT

A ratchet wrench includes a head with a ratchet wheel received in the first room in the head. A second room is defined in the inner periphery of the first room. The head has a top closed portion and a bottom closed portion, the second room is located between the top and bottom closed portions. A pawl is located in the second room and a resilient member is biased between the pawl and the inside of the second room so as to engage the pawl with the ratchet wheel. A positioning hole is defined through the top and bottom closed portions. A pin extends through the positioning hole and has a section located in the second room to restrict the movement of the pawl in the second room. The pawl can be made smaller than the pawls used in the conventional ratchet wrenches.

### BACKGROUND OF THE INVENTION

1. Fields of the Invention

The present invention relates to a ratchet wrench, and more particularly, to a ratchet wrench using a smaller pawl to save manufacturing cost.

2. Descriptions of Related Art

The conventional ratchet wrench is disclosed in U.S. Pat. No. 7,444,903, and comprises a wrench body having an end portion provided with a mounting hole and a receiving chamber connected to the mounting hole. A ratchet wheel is mounted in the mounting hole of the wrench body and has an outer wall provided with a plurality of ratchet teeth. A pawl member defining a top surface and a bottom surface is mounted in the receiving chamber of the wrench body, and has a first side including a first end provided with a plurality of locking teeth extending from the top surface to the bottom surface so as to be engaged with the ratchet teeth of the ratchet wheel successively and completely. A second end of the pawl member is provided with a sliding face extending from the top surface to the bottom surface slidable on the ratchet teeth of the ratchet wheel. The first and second ends define a whole circumferential length of the first side of the pawl member. An elastic member is mounted in the receiving chamber of the wrench body and biased between a peripheral wall of the receiving chamber of the wrench body and a second side of the pawl member to push the pawl member toward the ratchet wheel. The elastic member is located adjacent to the sliding face of the pawl member and the sliding face of the pawl member is located between the elastic member and the locking teeth of the pawl member. The first side of the pawl member is a concave surface which extends through the whole circumferential length of the first side of the pawl member. The sliding face of the pawl member is a concave recessed smooth surface which extends successively and completely through a circumferential length of the second end of the first side of the pawl member that is half of the circumferential length of the first side of the pawl member. The pawl member is movable relative to the ratchet wheel between a first position where all of the locking teeth of the pawl member are engaged with the ratchet teeth of the ratchet wheel closely and completely, and the sliding face of the pawl member evades the ratchet teeth of the ratchet wheel, and a second position where all of the locking teeth of the pawl member are disengaged from the ratchet teeth of the ratchet wheel, and the sliding face of the pawl member is movable on the ratchet teeth of the ratchet wheel.

In order to prevent the elastic member from randomly moved within the receiving chamber, the pawl member has to be made to be big enough so as to restrict the room that the elastic member moves. However, the pawl member is now made by way of injection molding instead of powder metallurgy, and this means that the bigger size of the pawl member is made, the higher manufacturing cost is applied. Besides, because the pawl member is pushed by the elastic member along the direction that is shown by the arrowhead, this causes the right rear side of the pawl member not to firmly contact against the inside of the receiving chamber, so that the engagement between the pawl member and the ratchet wheel is not secured.

The present invention intends to provide a ratchet wrench to eliminate the shortcomings mentioned above.

### SUMMARY OF THE INVENTION

The present invention relates to a ratchet wrench and comprises a head having a handle connected thereto, and the head has a first room defined therethrough. A second room is defined in the inner periphery of the first room. The center of the second room is located within the first room. The second room is located between a top closed portion and a bottom closed portion of the head. A first groove is defined in the inner periphery of the first room. A ratchet wheel is rotatably located in the first room and has multiple ratchet teeth defined in the outer periphery thereof. The ratchet teeth are located at the middle portion of the ratchet wheel. A mounting portion is defined axially in the ratchet wheel. A second groove is defined in the outer periphery of the ratchet wheel and located corresponding to the first groove. The ratchet wheel has a first outer surface and a second outer surface. The ratchet teeth are located between the first and second outer surfaces. A pawl is located in the second room and has multiple engaging teeth defined in the front side thereof. The engaging teeth are engaged with the ratchet teeth. A curved face is defined in the rear side of the pawl, and a recess is defined in the curved face. A protrusion extends from one end of the curved face. A resilient member has its first end received in the recess, and the second end of the resilient member contacting the inside of the second room. The resilient member biases the pawl to be engaged with the ratchet wheel. A clip is engaged with the first and second grooves to restrict the ratchet wheel in the first room. A pin has a middle section thereof located in the second room to restrict movement of the pawl in the second room.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a perspective view to show the ratchet wrench of the present invention;

FIG. 3 is a side view to show the ratchet wrench of the present invention;

FIG. 4 is a cross sectional view, taken along line A-A in FIG. 3;

FIG. 5 is a front ide view to show the ratchet wrench of the present invention;

FIG. 6 is a cross sectional view, taken along line B-B in FIG. 5;

FIG. 7 shows that the pawl is separated from the ratchet wheel of the ratchet wrench of the present invention;

FIG. 8 is an exploded view of the second embodiment of the ratchet wrench of the present invention;

FIG. 9 is a perspective view to show the third embodiment of the ratchet wrench of the present invention;

FIG. 10 is a perspective view to show the fourth embodiment of the ratchet wrench of the present invention;

FIG. 11 is a perspective view to show the fifth embodiment of the ratchet wrench of the present invention, and

FIG. 12 is a perspective view to show the sixth embodiment of the ratchet wrench of the present invention.

### DETAILED DESCRIPTION OF THE PREFERRED EMBODIMENT

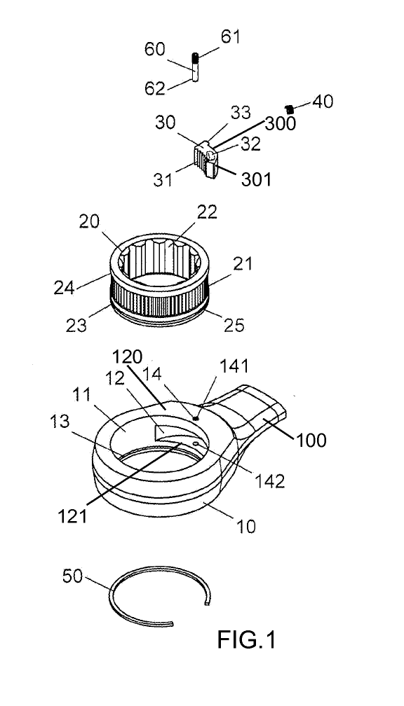

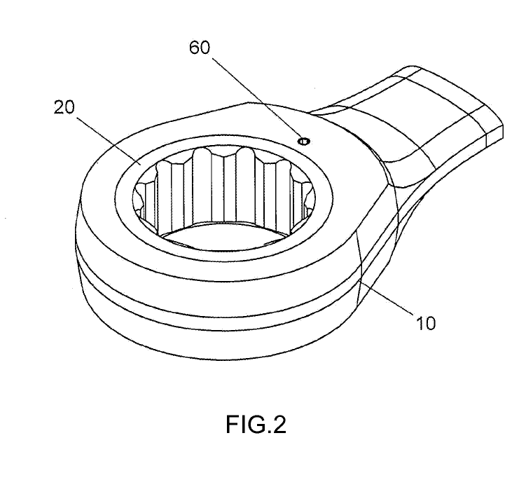

Referring to FIGS. 1 to 5, the ratchet wrench of the present invention comprises a head 10 having a handle 100 connected thereto. The head 10 has a first room 11 defined therethrough, and a second room 12 is defined in the inner periphery of the first room 11. The diameter of the second room 12 is smaller than that of the first room 11, and the center of the second room 12 is located within the first room 11. The second room 12 is located between a top closed portion 120 and a bottom closed portion 121 of the head 10. A first groove 13 is defined in the inner periphery of the first room 11. The head 10 has a positioning hole 14 defined through the top closed portion 120 and the bottom closed portion 121 thereof. The positioning hole 14 communicates with the second room 12. The axis of the positioning hole 14 is parallel with the axis of the first room 11. The positioning hole 14 includes a first hole 141 defined through the top closed portion 120, and a second hole 142 defined through the bottom closed portion 121. The first hole 141 has inner threads, and the second hole 142 has a smooth and circular inner periphery.

A ratchet wheel 20 is rotatably located in the first room 11 and has multiple ratchet teeth 21 defined in the outer periphery thereof. The ratchet teeth 21 are located at the middle portion of the ratchet wheel 20. A polygonal mounting portion 22 is defined axially in the ratchet wheel 20 so as to be mounted to a polygonal object such as a nut or a screw. A second groove 23 is defined in the outer periphery of the ratchet wheel 20 and located corresponding to the first groove 13. The ratchet wheel 20 has a first outer surface 24 and a second outer surface 25. The ratchet teeth 21 are located between the first and second outer surfaces 24, 25. The diameter of the first outer surface 24 is the same as that of the second outer surface 25. The tips of the ratchet teeth 21 protrude beyond the first and second outer surfaces 24, 25.

A pawl 30 is located in the second room 12 and has multiple engaging teeth 31 defined in the front side thereof. The engaging teeth 31 are engaged with the ratchet teeth 21. A curved face 300 is defined in the rear side of the pawl 30. A recess 32 is defined in the curved face 300. A protrusion 33 extends from one end of the curved face 300, and a curved contact face 301 extends from another end of the curved face 300. The curved contact face 301 and the second room 12 have a same radius. A resilient member 40 has the first end thereof received in the recess 32, and the second end of the resilient member 40 contacts the inside of the second room 12. The resilient member 40 biases the pawl 30 to be engaged with the ratchet wheel 20. A C-shaped clip 50 is engaged with the first and second grooves 13, 23 to restrict the ratchet wheel 20 in the first room 11. A pin 60 extends through the positioning hole 14 and has its middle section thereof located in the second room 12 to restrict movement of the pawl 30 in the second room 12. The pin 60 includes a first end 61 and a second end 62, wherein the first end 61 extends through the first hole 141 and the second end 62 extends through the second hole 142. The first end 61 of the pin 60 has outer threads which are engaged with the inner threads of the first hole 141. The second end of the pin 60 has a circular cross section which extends through the second hole 142.

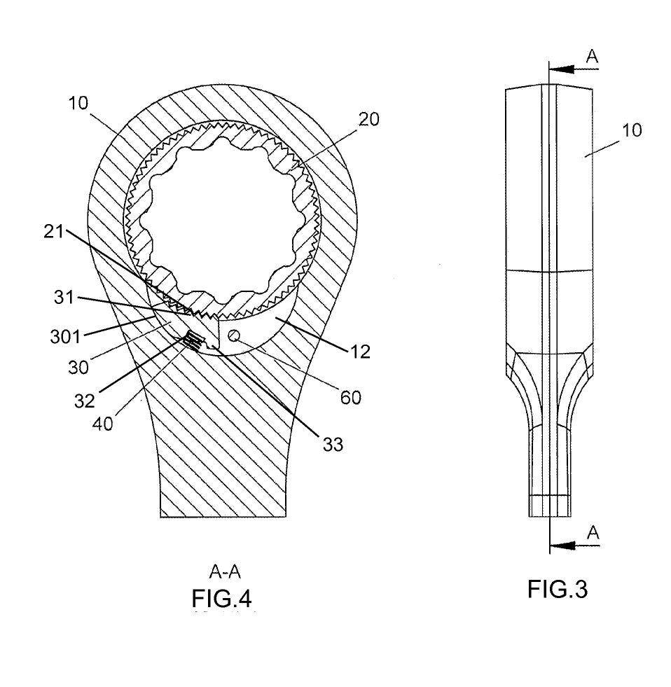

As shown in FIGS. 3 and 4, the pawl 30 is received in the second room and biased by the resilient member 40. The pawl 30 positions at the left inside of the second room 12, and the curved contact face 301 contacts and matches with the wall of the second room 12 when the resilient member 40 pushes the pawl 30 so that the engaging teeth 31 are engaged with the ratchet teeth 21. The pin 60 extends through the positioning hole 14. When rotating the head 10 counter clockwise, the engaging teeth 31 are engaged with the ratchet teeth 21.

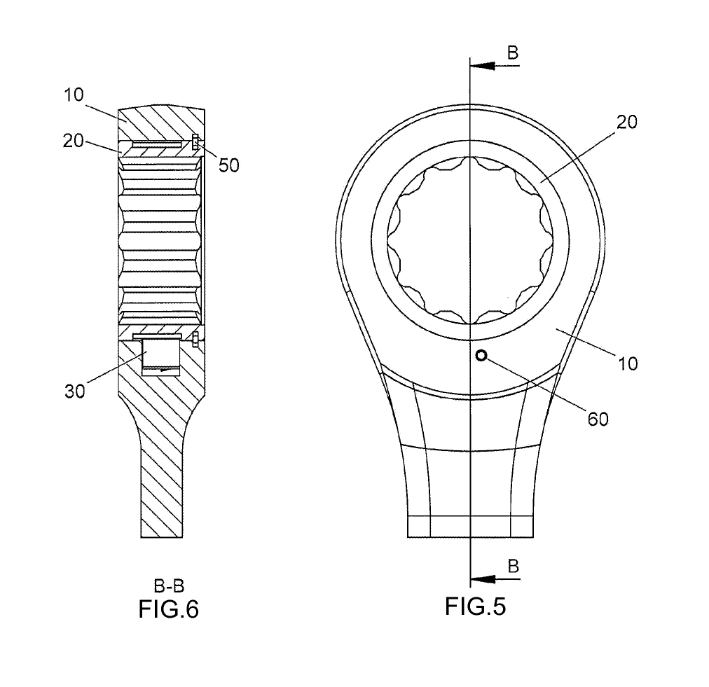

As shown in FIGS. 5 and 6, the first groove 13 is located corresponding to the second groove 23. The first outer surfaced 24 is located close to the top opening of the first room 11. The second outer surface 25 contacts the bottom opening of the first room 11. The clip 50 is engaged with the first and second grooves 13, 23 to allow the ratchet wheel 20 to be rotated in the first room 11.

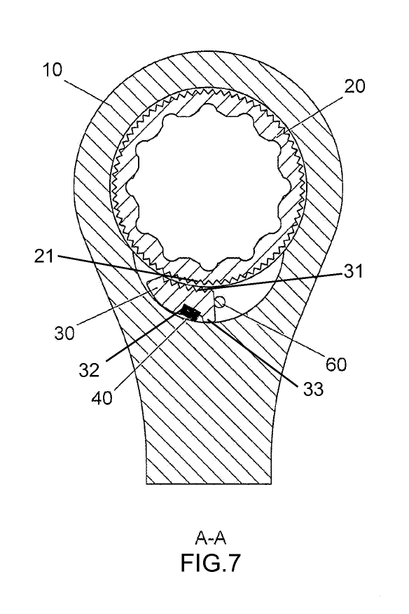

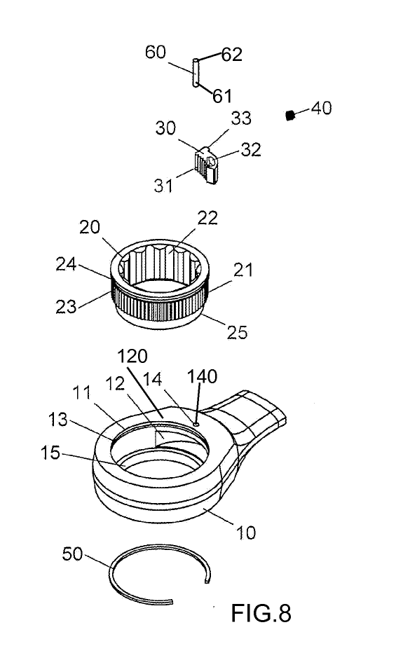

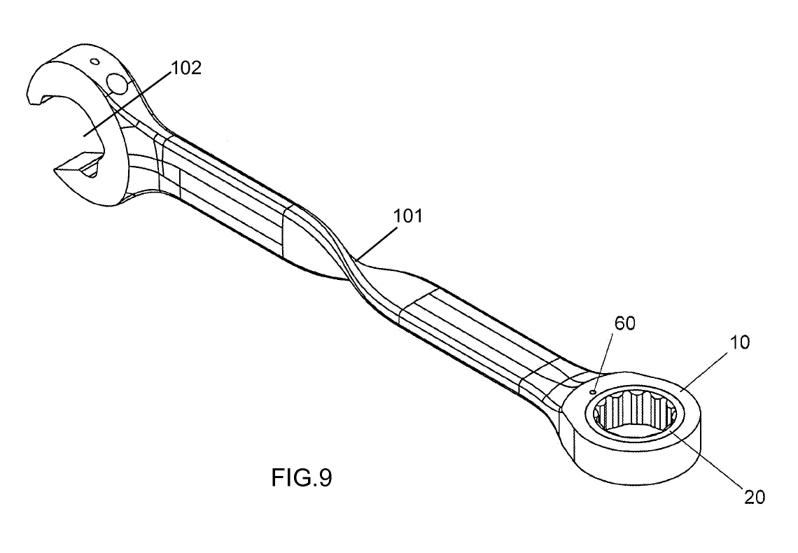

As shown in FIG. 7, when the head 10 is rotated clockwise, the engaging teeth 31 of the pawl 30 are separated from the ratchet teeth 21, the pawl 30 moves toward right and is restricted by the pin 60, and the distal end of the protrusion 33 contacts the wall of the second room 12. As shown in FIG. 8, the top closed portion 120 has a circular hole 140, the pin 60 has a first end 61 and a second end 62, the first end 61 has a circular cross section which extends through the circular hole 140. The first groove 13 is located at the upper portion of the first room 11. The second groove 23 is located at the first outer surface 24 of the ratchet wheel 20. A flange 15 extends inward from the lower portion of the first room 11. The inner diameter of the flange 15 is matched with the outer diameter of the second outer surface 25.

As shown in FIG. 9, the handle has an open end 102, and the middle portion of the handle 100 has a twist portion 101.

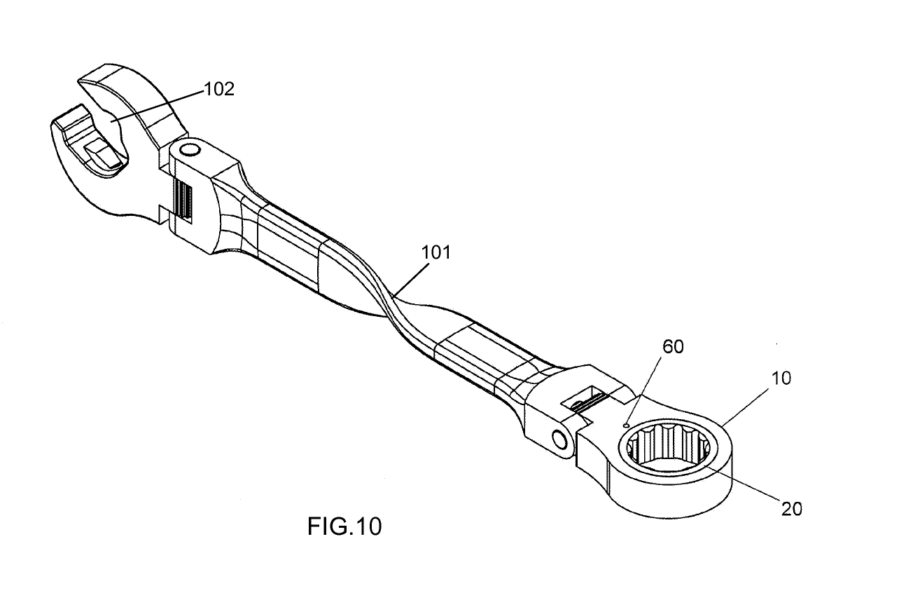

As shown in FIG. 10, the handle has an open end 102, and the middle portion of the handle 100 has a twist portion 101. The head 10 can be pivoted relative to the handle 100.

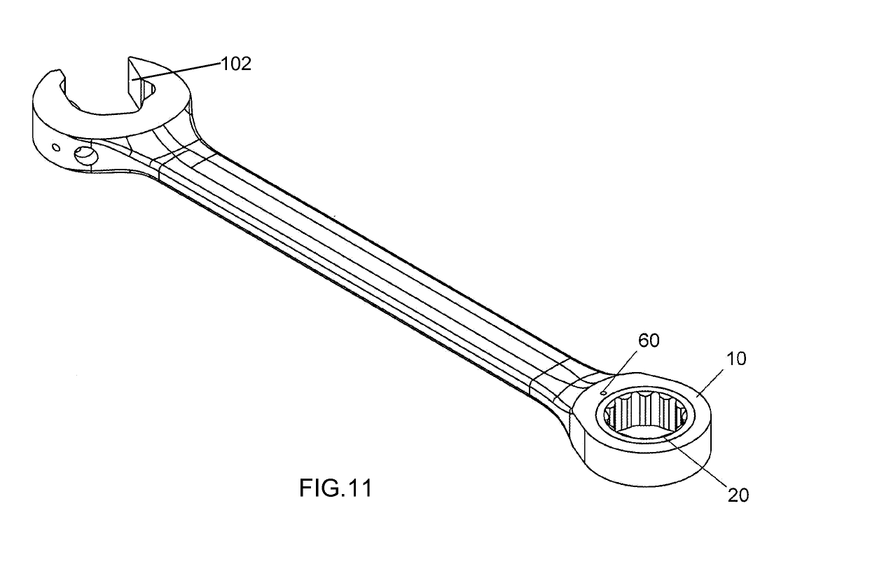

As shown in FIG. 11, the handle has an open end 102.

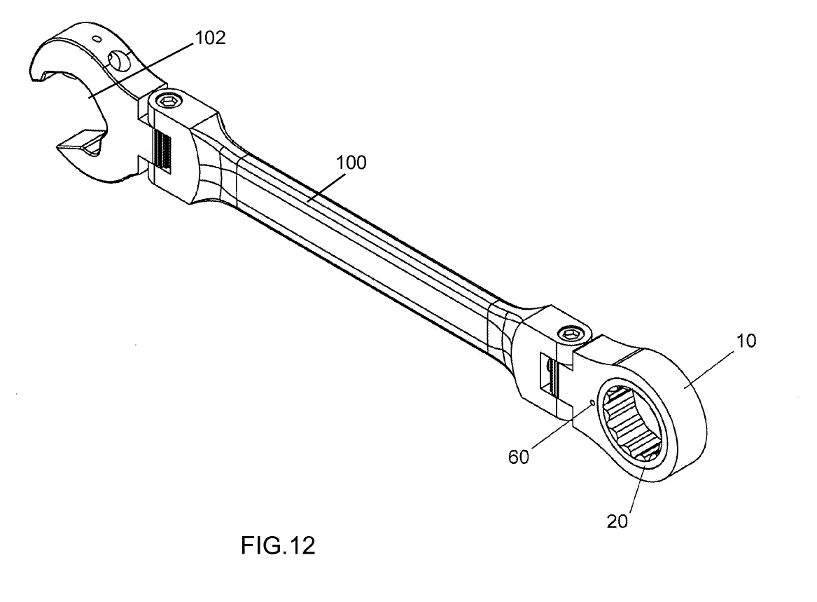

As shown in FIG. 12, the handle has an open end 102. The head 10 can be pivoted relative to the handle 100.

The pin 60 extends through the positioning hole 14 and the middle section of the pin 60 is located in the second room 12 so as to restrict the movement of the pawl 30. Therefore, the pawl 30 can be made to be ½ volume of the second room 12 so that the manufacturing cost is reduced.

When the pawl 30 is separated from the ratchet wheel 20 and moves in the second room 12, the pawl 30 is stopped by the pin 60, the engaging teeth 31 are completely separated from the ratchet teeth 21. The size of the pawl 30 can be reduced.

The resilient member 40 is located in the recess 32 of the pawl 30 and biased between the rea side of the pawl 30 and the inside of the second room 12. The curved face 300 is easily pushed by the resilient member 40 at an angle to contacts against the inside of the second room 12, so that the engagement between the engaging teeth 31 and the ratchet teeth 21 is secured.

While we have shown and described the embodiment in accordance with the present invention, it should be clear to those skilled in the art that further embodiments may be made without departing from the scope of the present invention.

What is claimed is:

1. A ratchet wrench comprising:
a head having a handle connected thereto, the head having a first room defined therethrough, a second room defined in an inner periphery of the first room, a diameter of the second room being smaller than that of the first room, a center of the second room being located within the first room, the second room being located between a top closed portion and a bottom closed portion of the head, a first groove defined in the inner periphery of the first room;
a ratchet wheel rotatably located in the first room and having multiple ratchet teeth defined in an outer periphery thereof, the ratchet teeth located at a middle portion of the ratchet wheel, a mounting portion defined axially in the ratchet wheel, a second groove defined in the outer periphery of the ratchet wheel and located corresponding to the first groove, the ratchet wheel having a first outer surface and a second outer surface, the ratchet teeth located between the first and second outer surfaces, a diameter of the first outer surface being the same as that of the second outer surface;
a pawl located in the second room and having multiple engaging teeth defined in a front side thereof, the engaging teeth engaged with the ratchet teeth, a curved face defined in a rear side of the pawl, a recess defined in the curved face;
a resilient member having a first end received in the recess, a second end of the resilient member contacting an inside of the second room, the resilient member biasing the pawl to be engaged with the ratchet wheel;
a clip engaged with the first and second grooves to restrict the ratchet wheel in the first room, and
a pin having a middle section thereof located in the second room to restrict movement of the pawl in the second room.

2. The ratchet wrench as claimed in claim 1, wherein a protrusion extends from one end of the curved face.

3. The ratchet wrench as claimed in claim 1, wherein a curved contact face extends from one end of the curved face, and the curved contact face and the second room have a same radius.

4. The ratchet wrench as claimed in claim 1, wherein the first groove is located at a lower portion of the first room, the second groove is located at the second outer surface of the ratchet wheel.

5. The ratchet wrench as claimed in claim 1, wherein the first groove is located at an upper portion of the first room, the second groove is located at the first outer surface of the ratchet wheel, a flange extends inward from a lower portion of the first room, an inner diameter of the flange is matched with an outer diameter of the second outer surface.

6. The ratchet wrench as claimed in claim 1, wherein the head has a positioning hole defined through a top and a bottom thereof, the positioning hole communicates with the second room, an axis of the positioning hole is parallel with an axis of the first room, the positioning hole includes a first hole defined through the top closed portion and a second hole defined through the bottom closed portion, the pin extends through the positioning hole, the pin includes a first end and a second end, the first end extends through the first hole and the second end extends through the second hole.

7. The ratchet wrench as claimed in claim 6, wherein the first hole has inner threads, the second hole has a smooth and circular inner periphery, the first end of the pin has outer threads which are engaged with the inner threads of the first hole, the second end of the pin has a circular cross section which extends through the second hole.

8. The ratchet wrench as claimed in claim 1, wherein the top closed portion has a circular hole, the pin has a first end and a second end, the first end has a circular cross section which extends through the circular hole.

9. The ratchet wrench as claimed in claim 1, wherein the mounting portion is a polygonal hole which is adapted to receive a polygonal object therein.
